(19) United States
(12) Patent Application Publication
(10) Pub. No.: US 2002/0046911 A1
(43) Pub. Date: Apr. 25, 2002

(54) Impact absorber

(76) Inventors: Michael Sacks, Manchester (GB); Peter Sajic, Broadstone (GB)

Correspondence Address: REISING ETHINGTON BARNES KISSELLE, LEARMAN AND MCCULLOCH PC, P O BOX 4390, TROY, MI, 48099-4390, US

(21) Appl. No.: 09/932,389

(22) Filed: Aug. 17, 2001

(30) Foreign Application Priority Data
Aug. 18, 2000 (GB) GB 0020367.9

(51) Int. Cl. F16F 7/12; B60R 21/055

(52) U.S. Cl. 188/377; 280/751

(57) ABSTRACT

A cellular component with cell walls aligned to be loaded in compression by an impact force applied to an impact surface of the absorber from which the cell walls extend laterally, wherein the cells walls are formed from multiple strips of material spaced apart across the impact surface but orientated so that adjacent sides of the walls abut and are joined at spaced regions along the length of the strips. The physical characteristics of the absorber can be varied to vary the impact absorbency longitudinally and/or laterally of the strips. The thickness of a cell wall can be varied either along one length of a strip and/or from one strip to another. The density or material of a cell wall can be varied. The depth of a cell may be adjusted by changing the width of a strip along a strip or from one strip to another. The cross-sectional area of a cell may be varied to give the cell a particular impact absorbency. The length of a joint between strips may also be varied.

### TECHNICAL FIELD

This invention relates to impact absorbs, especially a vehicle component to absorber impact.

### BACKGROUND OF THE INVENTION

A known impact absorber comprises a layer of rigid foam for mounting to a surface such as an interior surface of a passenger cell of a vehicle. The costs of manufacturing and shaping an impact absorber of this kind are relatively high. Inconsistencies caused by the molding process by which the foam is produced may cause the impact performance of the absorber to vary unpredictably across its impact absorbing surface. A rigid foam impact absorber may not offer good impact absorption performance at extreme temperatures, e.g. 110° C. and −40°C. Furthermore, rigid foam impact absorbers are usually fixed to surfaces with adhesives or fasteners which may make recycling difficult. There may also be undesirable limitations on the thickness of a rigid foam impact absorber due to the molding process used to create it. In addition, it is relatively difficult to manufacture a rigid foam impact absorber which has a controlled variation of impact absorbency across its surface or body.

Another known impact absorber comprises a honeycomb of aluminium. The walls of the honeycomb are arranged so as to be perpendicular to a local impact absorbing surface. An impact absorber of this kind is relatively expensive to produce and may be difficult to mould to a desired shape. An aluminium honeycomb may need to be machined to a correct shape. There can also be problems with corrosion and cell condensation. An aluminium honeycomb will normally be fixed to a surface using an adhesive or fasteners to the detriment of recyclability and/or performance. To provide a controlled variation of impact absorbency with an compact absorber of this type, different densities of honeycombs have to be used. Also aluminium honeycomb transmits sound efficiently, which is a major disadvantage within a vehicle passenger cell.

One object of the invention is to provide a vehicle component whose impact absorbency characteristics can be varied in a controlled manner with relative simplicity.

### SUMMARY OF THE INVENTION

According to the invention an impact absorber comprises a cellular component with cell walls aligned to be loaded in compression by an impact force applied to an impact surface of the absorber from which the cell walls extend laterally, wherein the cell walls are formed from multiple strips of material spaced apart across the impact surface but orientated so that adjacent sides of the walls abut and are joined at spaced regions along the length of the strips.

Advantageously, the physical characteristics of an impact absorber of this type can be varied to provide a controlled variation of impact absorbency longitudinally and/or laterally of the strips.

In general terms, the impact absorbency of a cell can be set by appropriately determining the material properties of the strips used to create the cell and the dimensions of the cell. The thickness of a cell wall can be varied by adjusting the thickness of the corresponding strip and the thickness can vary along one length of a strip and/or from one strip to another. The density of a cell wall can be varied by adjusting the density of a corresponding strip. The material of a cell wall can be changed by changing the composition of the material from which a strip is made. The depth of a cell may be adjusted by changing the width of a strip along a strip or from one strip to another.

The impact absorbency can also be varied by weakening a strip (by, for example, perforating it) to produce a weakened cell wall. Also, the cross-sectional area of a cell may be determined to give the cell a particular impact absorbency.

In a further embodiment, the impact absorbency may be varied by adjusting the length over which the joint between strips occurs so as to extend over the whole or only a part of the width of the strips. Also, a joint between two strips may run continuously or discontinuously across the width of the strips. The longitudinal (in the sense of the strips) extent of a joint between strips may be varied to adjust cell-strength.

The impact absorbency of one cell may be varied relative to another, or the impact absorbency of a group of cells may be varied with respect to that of other groups of cells.

It is also possible to strengthen the impact absorber by closing open cell ends (e.g. by melting a face of the impact absorber presenting open cell ends). Some or all of the cell ends on a face may be closed.

In one embodiment, the strips are made of a thermoplastic material. The strips may be joined to one another by welding.

Preferably, the strips overlie one another and run generally parallel to one another across their width. One or both of adjacent strips may undulate so as to bring them together at their joining points.

Preferably, the impact absorber can be formed or moulded to any desired shape, contour or size, so that the vehicle component adopts a desired configuration. The impact absorber is arranged such that the cells extend in the direction of expected impact forces (or at least substantially in such a direction).

The vehicle component may be a component which faces onto the external environment (such as a bumper or a bonnet or boot or “A” pillar or wheel arch or rubbing strip or any other component which might impact with a person externally of the vehicle). Alternatively, it may be a component which faces onto the interior of the passenger cell (such as a headliner for the passenger cell or a sun visor, head restraint, “A”, “B” or “C” pillar or a door, knee bolster below the dashboard, or rear of a front seat, or rear parcel tray or a loading floor over a spare wheel recess).

### BRIEF DESCRIPTION OF THE DRAWINGS

By way of example only, an embodiment of the invention will now be described with reference to the accompanying figures, in which:

FIG. 1 illustrates a plan view of an impact receiving face of an impact absorber;

FIG. 2 illustrates a cross-section on line a-a of FIG. 1;

FIG. 3 illustrates a manner of the varying impact absorption of the absorber of FIG. 1;

FIG. 4 illustrates another manner in which the impact absorption of an impact absorber can be varied; and

FIG. 5 and 6 illustrate further types of impact absorbers.

### DETAILED DESCRIPTION

The impact absorber 5 of FIG. 1 comprises a number of ribbons 10, 12, 14 and 16 of thermoplastic material which extend in the direction B. Ribbons 12 and 16 are drawn in thicker lines merely to differentiate them from ribbons 10 and 14. Each of the ribbons 10 to 16 has a substantially square-wave profile. Where the ribbons contact one another, i.e. at corners such as 18, they are welded together. The welds may extend partially or wholly over the width of the ribbons (i.e. that dimension extending into the plane of FIG. 1). Thus, the impact absorber 5 defines an array of cells, such as 20 and 22, of a square shape (of course, it is possible for the cells to be of other square cross-section).

An impact absorber comprising multiple ribbons of thermoplastic material welded together at longitudinally spaced points as shown in FIG. 1 may be manufactured by a process described in DE 19703961-A1. Alternatively, multiple ribbons can be fed in parallel through a welding head and an interdigital finger arrangement which is moved relative to the head and ribbons to form the ribbons into the required shape and join them together at welding points where the fingers and welding head come together.

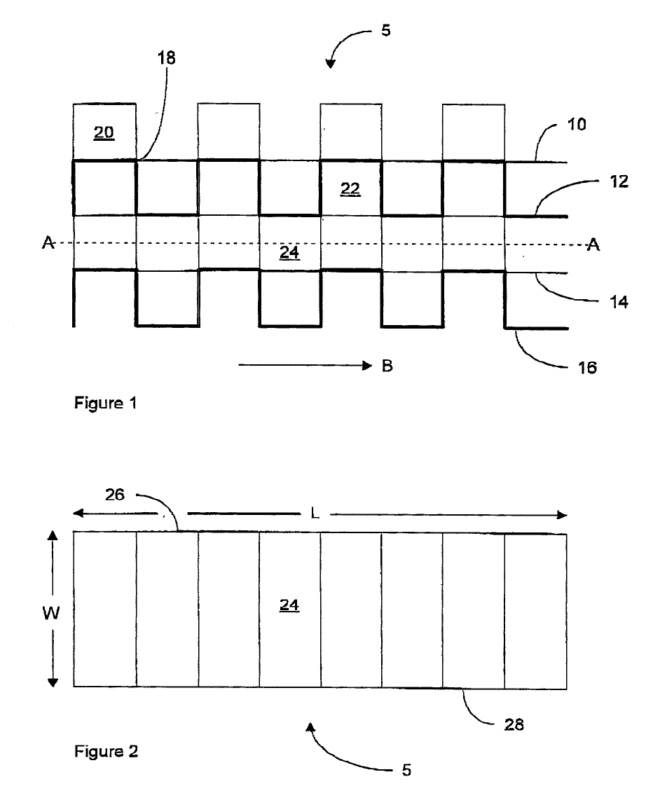

FIG. 2 shows a cross-section through impact absorber 5 on Line A-A. In FIG. 2, the dimension W indicates the width of the ribbons. Which is equal to the height of cells 24 and hence the thickness of the impact absorber 5. L defies the length of the impact absorber.

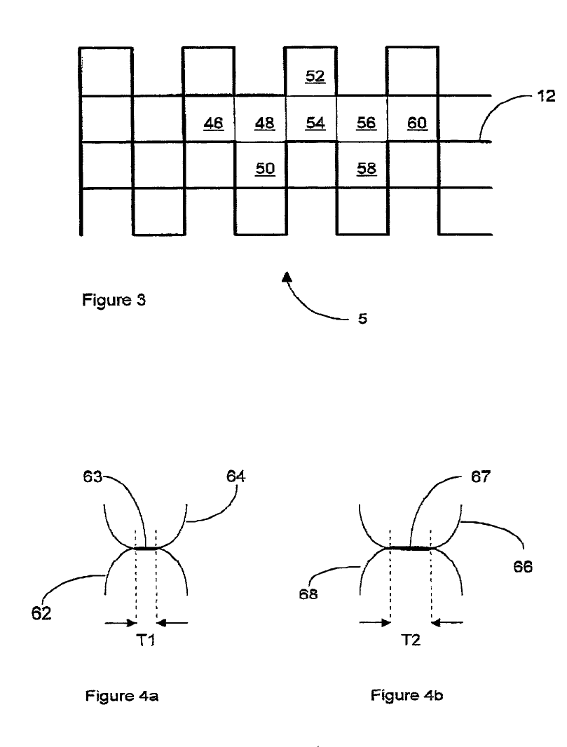

FIG. 3 illustrates how the impact absorbency of absorber 5 is varied. In FIG. 3, the thickness of the lines used to illustrate the ribbons 10 to 16 is indicative of the thickness of the ribbons. It will be apparent that a portion of ribbon 12 is of reduced thickness compared to the preceding and succeeding portions of that ribbon and the thickness of the other ribbons also. The thinned section of ribbon 12 is created by passing the ribbon 12 through a nip between two rollers prior to forming the absorber 5 and varying the pressure exerted by the rollers on the ribbon 12 to create the thinned portion. The result of thinning ribbon 12 is that cells 46 to 60 are weakened relative to the other cells. Less force is required to crush cells 46 to 60 than the surrounding cells. It will be apparent from the introduction that there are many other ways of varying the strength of the cells.

FIG. 4 illustrates a further method of varying the strength of the cells, either locally or globally. FIG. 4A illustrates a weld 63 between two ribbons constituting part of the impact absorber. It will be seen that the thickness of the weld 63 is T1. In FIG. 4B, which illustrates a weld 67 between two ribbons 66 and 68, the thickness of the weld 67 is T2. Since T2 is greater than T1, the impact absorber will be stronger, i.e. more crush resistant, in the region of the weld 67 shown in FIG. 4B than in the region of the weld 63 shown in FIG. 4A.

In use, the impact absorber 5 is intended to take an impact on either of faces 26 and 28, which lie substantially perpendicular to the extent of the cells. Upon receiving an impact, the walls of the cells, constituted by the ribbons, deform and hence the impact is absorbed. The impact absorber 5 is incorporated in a vehicle component, which, in the case of this embodiment, is a headliner for a passenger cell. The impact absorber is shaped to form part of the headliner such that the longitudinal axis of the cells extend into the passenger cell, i.e. either face 26 or 28 of the impact absorber 5 faces onto the passenger cell. This shaping may involve manipulating the impact absorber such that the faces 26 and 28 move away from the planar orientations shown.

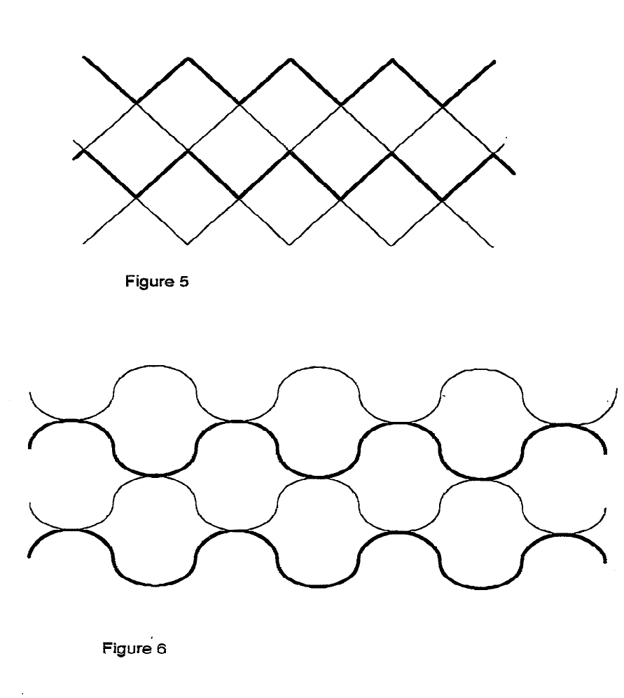

It will be apparent that almost any path may be adopted by the ribbons, provided that the paths of the ribbons bring them together to create the cells. FIGS. 5 and 6 illustrate alternative configurations of the impact absorber, wherein the ribbons undulate according to a triangular and a sinuous waveform, respectively. In FIGS. 5 and 6, the thickness of the lines representing the ribbons uses the convention of FIG. 1, i.e. bold and fine lines are used merely to allow the ribbons to be differentiated from one another. Of course, the impact absorbency of the absorbers illustrated in FIGS. 5 and 6 can be varied, either locally or globally, in accordance with any of the techniques contemplated herein.

1. A cellular impact absorber with cell walls aligned to be loaded in compression by an impact force applied to an impact surface of the absorber from which the cell walls extend laterally, wherein the cells walls are formed from multiple strips of material spaced apart across the impact surface but orientated so that adjacent sides of the walls abut and are joined at spaced regions along the length of the strips.

2. An impact absorber as claimed in claim 1 in which the strips of material are composed of thermoplastics material and are joined at said spaced regions by heat welding.

3. An impact absorber as claimed in claim 1 in which one or more strips vary in their properties to produce areas of the absorber with different levels of impact resistance.

4. An impact absorber as in claim 3 in which one or more strips vary in thickness along their length.

5. An impact absorber as claimed in claim 3 which is composed of strips of different thickness.

6. An impact absorber as claimed in claim 3 in which the density of one or more strips varies along its length.

7. An impact absorber as claimed in claim 3 which is composed of strips of different materials.

8. An impact absorber as claimed in claim 3 in which one or more strips vary in depth laterally of the impact surface along their length.

9. An impact absorber as claimed in claim 1 in which the cross-sectional area of cells vary to produce areas of the absorber with different levels of impact resistance.

10. An impact absorber as claimed in claim 1 in which the nature of the join between strips varies from one join to another to vary the impact resistance of the absorber in these regions.

11. An impact absorber as claimed in claim 10 in which the extent of the join between two strips over the width of the strips varies from one join to another.

12. An impact absorber as claimed in 10 in which the extent of the join between two strips over the length of the strips varies from one join to another.

13. An impact absorber as claimed in claims 10 in which one join is a continuous join and another is a discontinuous join.

14. An impact absorber as claimed in claim 1 in which one or more cells are closed at one end or both so as to vary the impact strength of the absorber in different regions.

15. An impact absorber as claimed in claim 1 which is moulded so that the impact absorbing surface is shaped to the use of the component in a vehicle.

16. An impact absorber as claimed in claim 15 which is adapted to be used in the passenger cell of a vehicle with the impact absorbing surface facing internally of the passenger cell.

17. An impact absorber as claimed in claim 15 which is adapted to be used externally of a vehicle with the impact absorbing surface facing outwards.
